(19) United States
(12) Patent Application Publication
(10) Pub. No.: US 2026/0048309 A1
(43) Pub. Date: Feb. 19, 2026

(54) PADDLE CORE STRUCTURE MADE OF CUSHIONING MATERIAL

(71) Applicant: Yujen CHANG, Taiwan (CN)

(72) Inventor: Yujen CHANG, Taiwan (CN)

(21) Appl. No.: 18/957,739

(22) Filed: Nov. 23, 2024

(30) Foreign Application Priority Data
Aug. 13, 2024 (CN) 2024219562457

(51) Int. Cl. A63B 60/54; A63B 59/42; A63B 102/08; B32B 3/30; B32B 5/02; B32B 5/18; B32B 5/24; B32B 25/10; B32B 25/14; B32B 27/12; B32B 27/30

(52) U.S. Cl. CPC A63B 60/54; A63B 59/42; B32B 3/30; B32B 5/02; B32B 5/18; B32B 5/245; B32B 25/10; B32B 25/14; B32B 27/12; B32B 27/306; A63B 2102/08; A63B 2209/02; B32B 2250/40; B32B 2262/101; B32B 2262/106; B32B 2307/56

(57) ABSTRACT

Disclosed is a paddle core structure made of a cushioning material. The core structure comprises a covering board layer and a structural layer, wherein the structural layer comprises male and female cushioning layers that are mated with each other, opposite sides of the male and female cushioning layers have mutually mated concave-convex structures, and the structural layer is formed after the concave-convex structures are aligned and mated; the male cushioning layer and the female cushioning layer are made of a mixture of a foam material with an EVA material or a mixture of a foam material and a polyurethane rubber material. The paddle core material made of a cushioning material according to the present invention can meet the requirement of light weight and combines the characteristics of various materials to achieve good striking noise reduction effect, good resilience, good core material durability and ensure the long service life of a paddle. Moreover, due to the combination of the male and female cushioning layers with different hardness, the two sides of the paddle have different hardness effects, bringing the advantages of different striking characteristics on the two sides.

### BACKGROUND OF THE INVENTION

### 1. Technical Field

The present invention relates to the technical field of ball sports equipment and, in particular, to the technical field of rough sheet composite fabrics in beach rackets and pickleball paddles.

### 2. Description of Related Art

With the rise of pickleball, more and more people and sports enthusiasts get themselves in pickleball activities, and the production process of pickleball paddles has been continuously upgraded and improved according to the needs of consumers to adapt to better use needs and provide better use experience.

Regardless of the pickleball paddle or the beach racket, they all need to meet the requirements of a certain degree of striking resilience and striking resistance. In addition to wear resistance and impact resistance, the requirement for light weight also should be considered. In view of this, high requirements for the production process and the selection of materials are made for pickleball paddle or the beach racket. For example, the patent publication CN202322998140.X provides a shock-absorbing wear-resistant pickleball paddle and discloses that opposite surfaces at the front and rear ends of a paddle board are provided with cushion surfaces, which can offset some impact force after the collision between a ball and the cushion surfaces and reduce the impact force received by the board, thereby achieving the effect of shock absorption.

However, as disclosed in the publication document, each cushion surface of the pickleball paddle is provided with a cushioning spring. This structure is complex and greatly increases the weight of the paddle, which is not conducive to reducing the overall weight of the paddle. And if only the good cushioning effect is taken into consideration without paying attention to the strength of the core material of the paddle, the obtained paddle is not durable and can be broken easily after a period of use, resulting in a short service life of the paddle and large loss.

### BRIEF SUMMARY OF THE INVENTION

In view of the above problems, the present invention provides a paddle core material which is made of a cushioning material. The paddle core material is made into a paddle with light weight, good cushioning effect, good striking resilience, use of a durable core material and a long service life.

The paddle core structure made of a cushioning material comprises a covering board layer and a structural layer, wherein the covering board layer comprises a first covering board layer and a second covering board layer, the structural layer is sandwiched between the first covering board layer and the second covering board layer, and the structural layer, the first covering board layer and the second covering board layer are hot-pressed into one through resin bonding layers applied thereto, wherein the structural layer comprises male and female cushioning layers that are mated with each other, opposite sides of the male and female cushioning layers have mutually mated concave-convex structures, and the structural layer is formed after the concave-convex structures are aligned and mated.

The structural layer comprises a male cushioning layer, a female cushioning layer and a core layer sandwiched between the male cushioning layer and the female cushioning layer; the cushioning layer facing a striking surface is defined as the male cushioning layer, and the cushioning layer that supports the male cushioning layer is defined as the female cushioning layer.

The core layer is made of a carbon fiber or glass fiber material and in a continuous concave-convex shape which matches the mutually mated concave-convex structures of the male and female cushioning layers.

The male cushioning layer and the female cushioning layer of the structural layer are mated and combined together by the concave-convex structures, wherein the concave-convex structures are triangular concave-convex groove structures, rectangular concave-convex groove structures or trapezoidal concave-convex groove structures.

The male cushioning layer and the female cushioning layer are both made of a foam material or an EVA material.

The male cushioning layer and the female cushioning layer are formed of a mixed material.

The male cushioning layer and the female cushioning layer are made of a mixed material obtained by mixing a foam material with an EVA material or by mixing a foam material and a polyurethane rubber material.

The paddle core material made of a cushioning material according to the present invention can meet the requirements of light weight and combines the characteristics of various materials to achieve good striking noise reduction effect, good resilience, good core material durability and ensure the long service life of a paddle. Moreover, due to the combination of the male and female cushioning layers with different hardness, the two sides of the paddle have different hardness effects, bringing the advantages of different striking characteristics on the two sides.

### BRIEF DESCRIPTION OF THE SEVERAL VIEWS OF THE DRAWINGS

FIG. 1 is a schematic diagram of a paddle core structure made of a cushioning material according to the present invention;

FIG. 2 is a schematic diagram of the paddle core structure made of a cushioning material according to the present invention fitted on a paddle in a longitudinal direction;

FIG. 3 is a schematic diagram of the paddle core structure made of a cushioning material according to the present invention fitted on a paddle in a transverse direction; and

FIG. 4 is a schematic diagram of a paddle core structure made of a cushioning material according to the present invention using triangular concave-convex groove structures;

where 10. covering board layer; 11. first covering board layer; 12. second covering board layer; 20. structural layer; 21. male cushioning layer; 22. female cushioning layer; 23. core layer; 30. concave-convex structure.

### DETAILED DESCRIPTION OF THE INVENTION

The invention is described in detail below in conjunction with the accompanying drawings and embodiments, examples of which are shown in the accompanying drawings, where identical or similar reference numerals from beginning to end indicate identical or similar elements or elements having the same or similar functions. The embodiments described below with reference to the accompanying drawings are illustrative and are intended only to explain the invention and are not to be construed as limitations on the invention.

In the description of the invention, it should be understood that the orientation or position relationships indicated by the terms “center”, “up”, “down”, “front”, “back”, “left”, “right”, “vertical”, “horizontal”, “top”, “bottom”, “inside”, “outside”, etc., are based on the orientation or position relationships shown in the accompanying drawings and are used only for the convenience of describing the invention and simplifying the description, rather than indicating or implying that the device or element referred to must have a specific orientation, be constructed and operated in a specific orientation. Therefore, they should not be understood as limiting the invention.

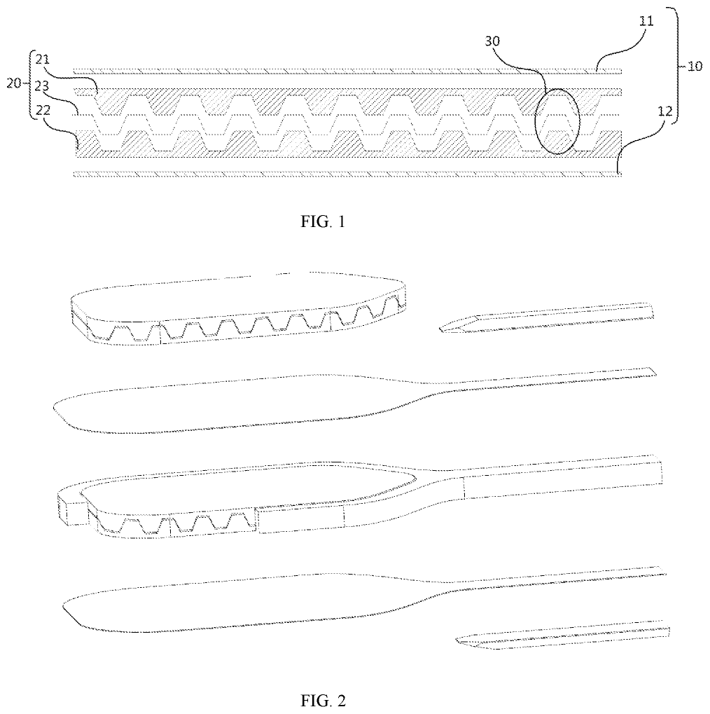

Referring to FIG. 1, the paddle core structure made of a cushioning material comprises a covering board layer 10 and a structural layer 20, wherein the covering board layer 10 comprises a first covering board layer 11 and a second covering board layer 12, the structural layer 20 is sandwiched between the first covering board layer 11 and the second covering board layer 12, and the structural layer 20, the first covering board layer 11 and the second covering board layer 12 are hot-pressed into one through resin bonding layers applied thereto, wherein the structural layer 20 comprises male and female cushioning layers that are mated with each other, opposite sides of the male and female cushioning layers have mutually mated concave-convex structures 30, and the structural layer 20 is formed after the concave-convex structures 30 are aligned and mated.

The structural layer 20 comprises a male cushioning layer 21, a female cushioning layer 22 and a core layer 23 sandwiched between the male cushioning layer 21 and the female cushioning layer 22; the cushioning layer facing a striking surface is defined as the male cushioning layer 21, and the cushioning layer that supports the male cushioning layer is defined as the female cushioning layer 22.

The core layer is made of a carbon fiber or glass fiber material and in a continuous concave-convex shape which matches the mutually mated concave-convex structures of the male and female cushioning layers. The carbon fiber or glass fiber is used to support the male and female cushioning layer structures, which highlights the high strength of the carbon fiber and glass fiber. Moreover, the carbon fiber or glass fiber is also an excellent memory material with good pressure deformation resistance, and can maintain the shape of the concave-convex structures of the male and female cushioning layers.

The male cushioning layer 21 and the female cushioning layer 22 of the structural layer 20 are mated and combined together by the concave-convex structures 30, wherein the concave-convex structures 30 are triangular concave-convex groove structures, rectangular concave-convex groove structures or trapezoidal concave-convex groove structures. With the concave-convex structures, the male and female cushioning layers can be mated with each other to limit positions, thereby avoiding large deformation and displacement in the process of thermoforming and hot pressing.

The male cushioning layer 21 and the female cushioning layer 22 are both made of a foam material or an EVA material.

Further, the male cushioning layer 21 and the female cushioning layer 22 may also be formed of a mixed material.

The mixed material is obtained in two ways. One is to mix a foam material with an EVA material to obtain the mixed material for the male cushioning layer and the female cushioning layer. The other is to mix a foam material with a polyurethane rubber material to obtain the mixed material for the male cushioning layer and the female cushioning layer. The mixed material of the foam material and the EVA material or the mixed material of the foam material and the polyurethane rubber is formed first, and then the male cushioning layer and the female cushioning layer are formed of the mixed material.

The male cushioning layer 21 and the female cushioning layer 22 may be made of foam materials with different foaming degrees. Their main parameters are reflected in different material density brought by different foaming degrees. If the material has high density and compacted texture, the paddle will be harder with moderate resilience and can strike a ball vigorously. If the material has low density and soft texture, the paddle will be softer and more resilient. Therefore, the male cushioning layer and the female cushioning layer which are different are used to make a paddle core material, which can realize the combination of coverings with different hardness on two sides of a paddle, so that the two sides of the paddle have different striking characteristics: one side is soft and comfortable, and the other side is hard and compact.

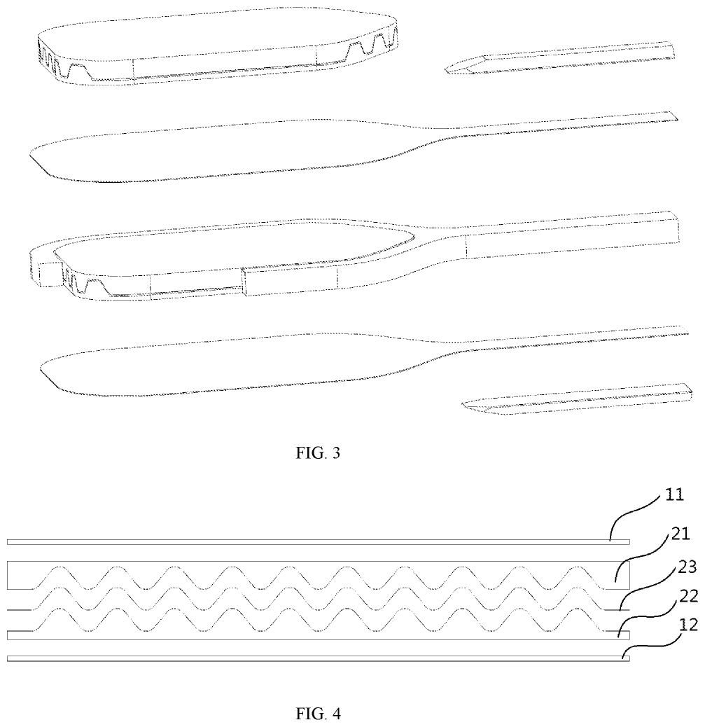

After the material is hot-pressed into one, the product shape is die cut according to the shape of the paddle, and the core material may also be molded into the shape of the paddle covering. Finally, a paddle covering material is made, and the paddle core structure may be fitted on the paddle board in a longitudinal direction, as shown in FIG. 2. The paddle core structure may also be fitted on the paddle board in a transverse direction, as shown in FIG. 3.

The paddle core material made of a cushioning material according to the present invention can meet the requirements of light weight and combines the characteristics of various materials to achieve good striking noise reduction effect, good resilience, good core material durability and ensure the long service life of a paddle. Moreover, due to the combination of the male and female cushioning layers with different hardness, the two sides of the paddle have different hardness effects, bringing the advantages of different striking characteristics on the two sides.

The above is only a preferred embodiment of the invention and is not intended to limit the invention in any form. Although the invention is disclosed as above by a preferred embodiment, the preferred embodiment is not for the purpose of defining the invention. Any person skilled in the art, within the scope of the technical solution of the invention, shall make some changes or modifications using the technical content disclosed as equivalent embodiments of the equivalent changes. However, any simple modification, equivalent change and modification of the above embodiments made according to the technical solution of the invention without departing from the content of the technical solution of the invention shall fall within the scope of the technical solution of the invention.

What is claimed is:

1. A paddle core structure made of a cushioning material, characterized by comprising a covering board layer and a structural layer, wherein the covering board layer comprises a first covering board layer and a second covering board layer, the structural layer is sandwiched between the first covering board layer and the second covering board layer, and the structural layer, the first covering board layer and the second covering board layer are hot-pressed into one through resin bonding layers applied thereto, wherein the structural layer comprises male and female cushioning layers that are mated with each other, opposite sides of the male and female cushioning layers have mutually mated concave-convex structures, and the structural layer is formed after the concave-convex structures are aligned and mated.

2. The paddle core structure made of a cushioning material according to claim 1, characterized in that the structural layer comprises a male cushioning layer, a female cushioning layer and a core layer sandwiched between the male cushioning layer and the female cushioning layer; the cushioning layer facing a striking surface is defined as the male cushioning layer, and the cushioning layer that supports the male cushioning layer is defined as the female cushioning layer.

3. The paddle core structure according to claim 2, characterized in that the core layer is made of a carbon fiber or glass fiber material and in a continuous concave-convex shape which matches the mutually mated concave-convex structures of the male and female cushioning layers.

4. The paddle core structure made of a cushioning material according to claim 1, characterized in that the male cushioning layer and the female cushioning layer of the structural layer are mated and combined together by the concave-convex structures, wherein the concave-convex structures are triangular concave-convex groove structures, rectangular concave-convex groove structures or trapezoidal concave-convex groove structures.

5. The paddle core structure made of a cushioning material according to claim 4, characterized in that the male cushioning layer and the female cushioning layer are both made of a foam material or an EVA material.

6. The paddle core structure made of a cushioning material according to claim 4, characterized in that the male cushioning layer and the female cushioning layer are prefabricated from a mixed material.

7. The paddle core structure made of a cushioning material according to claim 6, characterized in that the male cushioning layer and the female cushioning layer are made of a mixture of a foam material with an EVA material or a mixture of a foam material and a polyurethane rubber material.
